(19) United States
(12) Patent Application Publication
(10) Pub. No.: US 2006/0268217 A1
(43) Pub. Date: Nov. 30, 2006

(54) SIDE GUARDS FOR EYEGLASSES

(75) Inventor: Wei-Che Teng, Wan Lee (TW)

Correspondence Address: NIKOLAI & MERSEREAU, P.A., 900 SECOND AVENUE SOUTH, SUITE 820, MINNEAPOLIS, MN, 55402, US

(73) Assignee: IRENE CORPORATION, Wan Lee (TW)

(21) Appl. No.: 10/908,798

(22) Filed: May 26, 2005

(51) Int. Cl. G02C 5/00

(52) U.S. Cl. 351/41

(57) ABSTRACT

A pair of eyeglasses with side guard for screen sunlight and dust comprise a frame fitted with two lenses; two temples secured to both ends of the frame, each temple including a rail extended from a bottom of a butt-strap thereof, and an enlarged stopper at a forward end of the rail; and two exchangeable side guards each including a top groove extended rearward from a forward opening, the groove having a section conformed to that of the rail, and a slope at its forward end. Sliding the groove along the rail until being stopped by the stopper will secure the side guard to the temple.

### BACKGROUND OF THE INVENTION

1. Field of Invention

The present invention relates to eyeglasses and more particularly to a pair of side guards each adapted to mount at a mated rail under a butt-strap of either temple of eyeglasses (e.g., sunglasses) by sliding so as to screen sunlight and dust.

2. Related Art

Conventionally, for a pair of eyeglasses a side guard is fixedly formed under a butt-strap of either temple. The side guards can protect a portion of the face when a person wears a pair of eyeglasses. However, such fixed side guards inhibit change thereof especially in the case of sunglasses. Moreover, a broken side guard may force a user to discard the whole eyeglasses. Thus, the need for improvement still exists.

### SUMMARY OF THE INVENTION

It is therefore an object of the present invention to provide a pair of eyeglasses with side guards for screening sunlight and dust comprising a frame fitted with two lenses; two temples secured to both ends of the frame, each temple including a rail extended from a bottom of a butt-strap thereof, and an enlarged stopper at a forward end of the rail; and two exchangeable side guards each including a top groove extended rearward from a forward opening, the groove having a section conformed to that of the rail, and a slope at its forward end, whereby sliding the groove along the rail until the slope is stopped by the stopper will secure the side guard to the temple.

The above and other objects, features and advantages of the present invention will become apparent from the following detailed description taken with the accompanying drawings.

### BRIEF DESCRIPTION OF THE DRAWINGS

FIG. 1 is an exploded view of a portion of eyeglasses incorporating a preferred embodiment of side guards according to the invention;

FIG. 2 is a side view of the partially assembled components in FIG. 1;

FIG. 3 is a sectional view of the assembled temple and side guard in FIG. 2; and

FIG. 4 is a perspective view of a pair of eyeglasses mounted with the side guards.

### DETAILED DESCRIPTION OF THE INVENTION

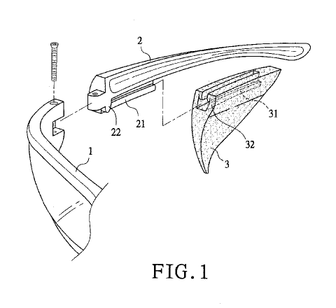

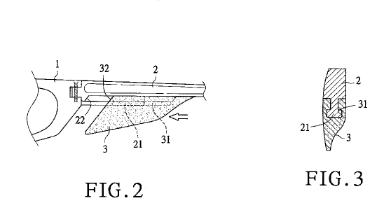

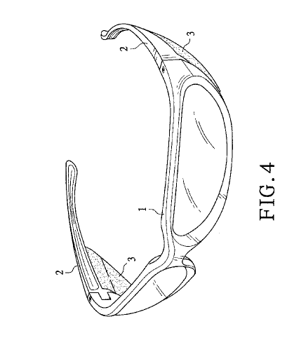

Referring to FIGS. 1, 2, 3, and 4, a pair of eyeglasses with side guards for screening sunlight and dust (e.g., sunglasses as shown) in accordance with a preferred embodiment of the invention comprise a frame 1 fitted with lenses, two temples 2 (one is shown) threadedly secured to both ends of the frame 1, and two sliding side guards 3 (one is shown). Each temple 2 includes a rail 21 of inverted T section extended from a bottom of a butt-strap portion, and an enlarged stopper 22 at a forward end of the rail 21. Each side guard includes a top elongate groove 31 of T section extended rearward from a forward opening, and a slope 32 at its forward end coincided with the stopper 22. In assembly, first align the groove 31 with a rear end of the rail 21. Next, slide the side guard 3 along the rail 21 until the slope 32 is stopped by the stop member 22. As shown in FIG. 3, the rail 21 is snugly fitted in the groove 31. Also, the slope 32 is shaped to conform to a portion of the frame 1 and a rear portion of the stoper 22 in the assembled position (see FIG. 4).

A person may buy another pair of side guards 3 for replacing the existing ones if such need arises as long as the new side guards 3 have the requisite components including the grooves 31 and the slopes 32 as above.

While the invention herein disclosed has been described by means of specific embodiments, numerous modifications and variations could be made thereto by those skilled in the art without departing from the scope and spirit of the invention set forth in the claims.

What is claimed is:

1. A pair of eyeglasses with side guards comprising:
a frame fitted with two lenses;
two temples securred to both ends of the frame, each temple including a rail extended from a bottom of a butt-strap thereof, and an enlarged stopper at a forward end of the rail; and
two exchangeable side guards for screening sunlight and dust each including a top groove extended rearward from a forward opening, the groove having a section conformed to that of the rail, and a slope at its forward end,
whereby sliding the groove along the rail until the slope is stopped by the stopper will secure the side guard to the temple.
